(19) United States
(12) Patent Application Publication
(10) Pub. No.: US 2022/0186007 A1
(43) Pub. Date: Jun. 16, 2022

(54) BIMODAL TERPOLYMER

(71) Applicant: BOREALIS AG, Vienna (AT)

(72) Inventors: Luca Boragno, Linz (AT); Pauli Leskinen, Porvoo (FI); Friedrich Berger, Linz (AT); Elena Pomakhina, Linz (AT)

(21) Appl. No.: 17/426,132

(22) PCT Filed: Jan. 30, 2020
(86) PCT No.: PCT/EP2020/052233

§ 371 Date: Jul. 28, 2021

(30) Foreign Application Priority Data
Feb. 1, 2019 (EP) 19155051.6

(51) Int. Cl. C08L 23/14

(52) U.S. Cl. CPC C08L 23/14; C08L 2205/025

(57) ABSTRACT

New bimodal propylene terpolymer, which combines low sealing initiation temperature (SIT), high melting temperature, good processability and good optical properties, like low haze, its use and articles made therefrom.

The present invention is related to a new bimodal propylene terpolymer, which combines low sealing initiation temperature (SIT), high melting temperature, good processability and good optical properties, like low haze.

The present invention is furthermore related to the use of the propylene terpolymer and articles made therefrom.

Propylene copolymers and terpolymers are suitable for many applications such as packaging, textile, automotive and pipe. An important area of application of propylene polymers is the packaging industry, particularly in film application where sealing properties play an important role, e.g., heat sealing.

Heat sealing is the predominant method of manufacturing flexible and semi-rigid packages. Important characteristics of good sealing performance are:

a) low seal initiation temperature (SIT), which is needed to support high speed on packaging machines with low energy consumption,
b) broad sealing window, which is especially needed for processing window on HFFS (Horizontal Form, Fill and Seal) packaging lines and
c) additionally high melting point, which is important, for example in biaxially oriented PP (BOPP) films, to avoid stickiness and blocking and accomplish high BOPP line speeds.

To ensure fast sealing, a low SIT is of advantage. By operating at lower temperature there is the benefit that the article to be sealed is not exposed to high temperatures. There are also economic advantages since lower temperatures are of course cheaper to generate and maintain.

There are further advantages by avoiding high sealing temperatures, especially when temperature sensitive goods are to be packed.

Particularly demanding applications of films, like form and fill packaging require, besides low seal initiation temperature, good hot-tack properties. Hot-tack is the bonding strength measurable while the polymer in the heat sealed portion of a film is in a semi-molten/solidifying state.

This bonding strength is expressed here and hereafter in the hot tack force (N) needed to tear apart sealed layers. The hot-tack is generally an important factor to improve the efficiency of a packaging production process.

Additionally, it is also desired to have a packaging material with satisfying optical properties, such as low haze.

For use of such films in the food packaging area it is furthermore desirable that the xylene cold soluble (XCS) fraction of the material is limited to below 25.0 wt % and that the material contains no phthalate containing substances.

All film manufacturers, whether making multilayer or monolayer films are looking to maximise the properties of the film it produces. Maximisation of properties is normally easier with multilayer films as each layer can be tailored to provide a particular attribute of need. It is common for example to use an outer layer which can give rise to good sealing properties whilst a core layer might be used to provide mechanical strength to a film. Moreover, when using a multilayer construction, incompatibility between film components can be avoided by placing these in separate layers.

When a film is mono-layered however, the options available to the film manufacturer are much more limited. It is currently very difficult to prepare monolayer films having optimal properties, e.g. good mechanical and processing properties and the person skilled in the art is therefore looking for new films which can provide improvements to these. Especially problematic are optical properties as the more components used in a monolayer film, the higher the haze value of the film tends to be.

The problem faced by the film manufacturer is that by trying to improving one property, another equally important property tends to be detrimentally affected. There are also real problems of compatibility between different polymers in a monolayer construction where all components are extruded together as a blend. If polymer components are not compatible, inhomogeneity is evident in the formed film which is unacceptable for the manufacturer and consumer. This limits still further the parameters which the film chemist can manipulate.

Several attempts have been made to solve the problems mentioned above by providing blends of terpolymers and plastomers.

US 20050142367 proposes to use a blend of a propylene-1-butene-ethylene terpolymer with a metallocene catalyzed ethylene polymer for a heat sealable skin layer of a three-layer BOPP film to provide low seal initiation temperature (SIT) and good hot-tack properties. The metallocene catalyzed ethylene polymer can have a melt flow rate (MFR₂; 190° C., 2.16 kg) in the range of from 2.0 to 7.5 g/10 min and a density in the range of from 0.878 to 0.900 g/cm³.

The propylene-1-butene-ethylene terpolymer used in the examples contains a relatively high amount of comonomers, namely 1.1 wt % (i.e. 1.7 mol %) of ethylene and 20.0 wt % (i.e. 16.2 mol %) of 1-butene.

The melting point of such compositions, as well as stiffness will be by far too low. Optical properties, like haze, are not mentioned.

WO 2016091923 discloses films based on a blend of a propylene copolymer and an ethylene based plastomer with sealing initiation temperature (SIT) of at most 140° C. The Examples shown in WO 2016091923 use propylene-ethylene copolymers and ethylene based plastomer with a melt flow rate (MFR₂; 190° C., 2.16 kg) up to 10.0 g/10 min. The films prepared with these blends after surface treatment using a Corona Generator G20S show a sealing initiation temperature (SIT) at which the seal strength has reached 1.5 N in the range of from 127° C. to 138° C. This is by far too high.

No values for hot-tack and haze are indicated.

Also EP 3031849 discloses films based on a blend of a propylene copolymer and an ethylene based plastomer, the films having a haze according to ASTM D1003 for a film thickness of 50 μm of at most 2.0%.

The examples shown in EP 3031849 use propylene-ethylene copolymers and ethylene based plastomer with a melt flow rate (MFR₂; 190° C., 2.16 kg) up to 10.0 g/10 min, the films are again after surface treated using a Corona Generator G20S.

No values for hot-tack and sealing initiation temperature (SIT) are indicated, but based on the compositions shown in the examples, SIT is expected to be by far too high (>130° C.)

Also some bimodal terpolymers have been described in the past.

In WO 2015101593 an improved process for producing polypropylene terpolymer compositions exhibiting good balance between desired properties, like high hot tack strength, low heat sealing initiation temperature (SIT) and low amount of xylene soluble and low volatile organic compounds, and further containing low amounts of gels indicating low amounts of catalyst residues, typically originating from catalyst carrier, or low monomer conversion is proposed. In this polymerization method for producing propylene terpolymers the conversion of the monomers is improved.

According to the inventive Example IE1 a propylene-ethylene-butene terpolymer is produced in a sequential polymerization process, whereby in the loop a terpolymer with an ethylene content of 1.30 wt % is produced. The final terpolymer has a melting temperature of below 133° C. No values for SIT and haze are given. So no conclusions about sufficient/improved balance of low sealing initiation temperature (SIT) in combination with high melting temperature, good processability and good optical properties, like low haze, can be made.

WO 2016198601 again aims to provide an improved process for producing polymer compositions from propylene, a C4 to C8 a-olefin comonomer and ethylene, the compositions exhibiting good balance between desired properties, like good hot tack properties, low heat sealing initiation temperature (SIT), broad sealing temperature window, meaning a wide range between the sealing end temperature (SET) and SIT, a surprising relation between melting temperature and amount of solubles, low amount of volatile organic compounds (VOC) and further not comprising any phthalic compounds originating from compounds used in the process. In this process again the C4 to C8 comonomer conversion, or comonomer response, is on a good level, resulting in good process economics as well in desired properties. According to the inventive Examples and also the Comparative Examples propylene-ethylene-butene terpolymer are produced in a sequential polymerization process, whereby in the loop a terpolymer with an ethylene content of at least 0.9 wt % is produced for those Examples where the split for the loop fraction is below 50 wt %. For the final terpolymers of those Examples either the melting temperature is too low, i.e. below 133° C. or the SIT is too high, i.e. above 110° C. or a phthalate containing catalyst is used.

No values for tensile modulus and haze are given.

However, although much development work has already been done in the field of films suitable for different kinds of packaging, the films as disclosed in the prior art still do not provide a sufficient balance of low sealing initiation temperature (SIT) in combination with high melting temperature, good processability and good optical properties, like low haze, so that there still exists a need for novel and improved film structures, providing films with improved sealing behaviour, i.e. having an improved balance between high melting point and low sealing initiation temperature (SIT) thus having a broad sealing window and thermal stability in combination with improved optics.

Surprisingly the inventors found, that the above problems can be solved by a specific bimodal propylene terpolymer.

### SUMMARY OF THE INVENTION

Accordingly, the present invention relates in a first aspect to a bimodal propylene terpolymer, being a binary blend comprising two propylene polymer fractions PPF1 and PPF2 in specific amounts:

a) 25.0 wt % to less than or equal to 50.0 wt % of propylene polymer fraction PPF1 being a propylene terpolymer comprising propylene monomers, 0.1 to 0.8 wt % ethylene comonomer and 4.0 to 12.0 wt % of one comonomer selected from C₄-C₁₀ alpha-olefin and
b) more than or equal to 50.0 wt % up to 75.0 wt % of propylene polymer fraction PPF2 being a propylene terpolymer comprising propylene monomers, 1.0 to 5.0 wt % of ethylene comonomer and 4.0 to 15.0 wt % of one comonomer selected from C₄-C₁₀ alpha-olefin, whereby the amount of PPF1 and PPF2 being relative to the total sum of the propylene polymer fractions PPF1 and PPF2.
wherein the bimodal random propylene terpolymer has
i. a melting temperature (Tm) in the range of 133 to 160 QC as determined by DSC according to ISO 11357,
ii. a sealing initiation temperature (SIT), measured on a 50 μm cast film, in the range of 90 to <108° C.
iii. a total ethylene content in the range of 0.5 to 4.0 wt % and
iv. a total C₄-C₁₀ alpha-olefin comonomer content in the range of 5.0 to 14.0 wt %.

It has surprisingly been found out that such bimodal propylene terpolymers have an optimized or improved sealing behaviour, i.e. low sealing initiation temperature SIT and high melting temperature, in combination with beneficial optical properties.

In an embodiment of the present invention the bimodal random propylene terpolymer is obtainable, preferably obtained, in the presence of a phthalate free Ziegler-Natta catalyst.

In yet another embodiment the present invention is related to a monolayer film made of the above identified composition.

In a further aspect the present invention is related to the use of the mono-layer films according to the invention for lamination or mono- or multilayer films for packaging films and medical/hygienic films.

As alternative in one further aspect the present invention is related to the use of the monolayer films according to the invention as sealing layer in a polypropylene multi-layer film, which can be manufactured either by co-extrusion or lamination.

### DETAILED DESCRIPTION

### Bimodal Random Propylene Terpolymer

The bimodal propylene terpolymer according to the invention is a random terpolymer and comprises at least ethylene as first comonomer and a C₄ to C₁₀ α-olefin as the second comonomer.

Accordingly, the propylene terpolymer comprises, preferably consists of, units derived from propylene and from ethylene and from one further α-olefin selected from the group consisting of C₄-α-olefin, C₅-α-olefin, C₅-α-olefin, C₇-α-olefin, C₅-α-olefin, C₉-α-olefin and C₁₀-α-olefin. More preferably the propylene terpolymer comprises, preferably consists of, units derived from propylene and from ethylene and one other α-olefin selected from the group consisting of 1-butene, 1-pentene, 1-hexene, 1-heptene, 1-octene, 1-nonene and 1-decene, wherein 1-butene and 1-hexene are even more preferred.

It is in particular preferred that the propylene terpolymer consists of units derived from propylene, ethylene and 1-butene or from propylene, ethylene and 1-hexene.

Most preferred the propylene terpolymer consists of units derived from propylene, ethylene and 1-butene.

The propylene terpolymer according to this invention is featured by a moderate to low comonomer content, especially low ethylene comonomer content.

The comonomer content is measured with ¹³C{1H} NMR.

Accordingly the propylene terpolymer according to this invention has a total ethylene content in the range of from 0.5 to 4.0 wt %, preferably in the range of from 1.0 to 3.0 wt % and more preferably in the range of from 1.5 to 2.5 wt %.

Moreover, the propylene terpolymer has a total C₄ to C₁₀ α-olefin, preferably a C₄ or C₆ α-olefin comonomer content in the range of from 5.0 to 14.0 wt %, preferably in the range of from 6.0 to 12.0 wt % and more preferably in the range of from 8.0 to 10.0 wt %.

The propylene terpolymer has a melt flow rate MFR₂ (230° C.) measured according to ISO 1133 in the range of from 0.5 to 20.0 g/10 min, preferably in the range of from 0.8 to 15.0 g/10 min, more preferably in the range of from 1.0 to 10.0 g/10 min, still more preferably in range of from 2.0 to 8.0 g/10 min and yet more preferably in the range of 3.0 to 7.0 g/10 min.

Alternatively the propylene terpolymer can be defined by the melting temperature (Tm) measured via DSC according to ISO 11357. Accordingly, the propylene terpolymer has a melting temperature Tm of in the range of from 133° C. to 160° C. Preferable the melting temperature Tm is in the range of 133° C. to 145° C., more preferably in the range of 133° C. to 140° C.

The propylene terpolymer according to the invention is a binary blend comprising, preferably consisting of, propylene polymer fraction PPF1 and propylene polymer fraction PPF2.

The propylene polymer fraction PPF1 is present in the propylene terpolymer according to the invention in an amount of less than or equal to 50 wt %, preferably in an amount in the range of 25 to 50 wt %, more preferably in an amount in the range of 30 to 50 wt %. The amount of PPF1 being relative to the sum of the propylene polymer fractions PPF1 and PPF2.

The propylene polymer fraction PPF2 is present in the propylene terpolymer according to the invention in an amount of more than or equal to 50 wt %, preferably in an amount in the range of 50 to 75 wt %, more preferably in an amount in the range of 50 to 70 wt %. The amount of PPF2 being relative to the sum of the propylene polymer fractions PPF1 and PPF2, whereby the amounts of PPF1 and PPF2 sum up to 100%.

In the following the terms propylene polymer fraction PPF1 or propylene terpolymer PPF1, respectively propylene polymer fraction PPF2 or propylene terpolymer PPF2 are used interchangeable.

The propylene polymer fraction PPF1 is generally a propylene terpolymer comprising ethylene comonomer and one comonomer selected from C₄-C₁₀ alpha-olefin, preferably ethylene comonomer and one comonomer selected from C₄-C₈ alpha olefin comonomer, more preferably ethylene comonomer and one comonomer selected from C₄-C₆ alpha olefin comonomer, even more preferably ethylene comonomer and 1-butene (C₄).

The propylene terpolymer PPF1 generally has ethylene comonomer units in an amount of 0.1 to 0.8 wt %, preferably in an amount of 0.2 to 0.7 wt %. The amount of ethylene comonomer units is relative to the total amount of monomers in the propylene terpolymer PPF1.

The propylene terpolymer PPF1 generally has C₄-C₁₀ alpha-olefin comonomer units in an amount of 4.0 to 12.0 wt %, preferably in an amount of 5.0 to 11.0 wt %, more preferably in an amount of 6.0 to 10.0 wt %. The amount of C₄-C₁₀ alpha-olefin comonomer units is relative to the total amount of monomers in the propylene terpolymer PPF1.

Generally, the melt flow rate (MFR₂) for the propylene terpolymer PPF1 is 10.0 g/10 min. The MFR₂ for propylene terpolymer PPF1 is determined according to ISO 1133, at a temperature of 230° C. and under a load of 2.16 kg. It is preferred that the MFR₂ for the propylene terpolymer PPF1 is between 2.0 and 10.0 g/10 min, more preferably the MFR₂ is between 3.0 and 7.0 g/10 min.

The propylene polymer fraction PPF2 is generally also a propylene terpolymer comprising ethylene comonomer and one comonomer selected from C₄-C₁₀ alpha-olefin, preferably ethylene comonomer and one comonomer selected from C₄-C₈ alpha olefin comonomer, more preferably ethylene comonomer and one comonomer selected from C₄-C₆ alpha olefin comonomer, even more preferably ethylene comonomer and 1-butene (C₄).

The propylene terpolymer PPF2 generally has ethylene comonomer units in an amount of 1.0 to 5.0 wt %, preferably in an amount of 1.2 to 4.0 wt %, more preferably in an amount of 1.4 to 3.0 wt %. The amount of ethylene comonomer units is relative to the total amount of monomers in the propylene terpolymer PPF2.

The propylene terpolymer PPF2 generally has C₄-C₁₀ alpha-olefin comonomer units in an amount of 4.0 to 15.0 wt %, preferably in an amount of 5.0 to 13.0 wt %, more preferably in an amount of 6.0 to 11.0 wt %. The amount of C₄-C₁₀ alpha-olefin comonomer units is relative to the total amount of monomers in the propylene terpolymer PPF2.

The two terpolymers PPF1 and PPF2 differ especially in their amount of ethylene, i.e. the terpolymer fraction PPF1 has lower ethylene content than the terpolymer fraction PPF2, thus the propylene terpolymer being bimodal in view of ethylene content.

The propylene terpolymer can be produced by polymerization in the presence of any conventional coordination catalyst system including Ziegler-Natta, chromium and single site (like metallocene catalyst), preferably the propylene terpolymer is produced in the presence of a phthalate free Ziegler-Natta catalyst system.

The propylene terpolymer can be produced in a sequential polymerization process comprising at least two polymerization reactors (R1) and (R2), whereby in the first polymerization reactor (R1) a first propylene polymer fraction (R-PP1) is produced, which is subsequently transferred into the second polymerization reactor (R2). In the second polymerization reactor (R2) a second propylene polymer fraction (R-PP2) is then produced in the presence of the first propylene polymer fraction (R-PP1).

In the present case, the bimodal propylene terpolymer is a binary blend comprising, preferably consisting of, propylene polymer fraction 1 PPF1 and propylene polymer fraction 2 PPF2, thus in the first reactor (R1) propylene terpolymer PPF1 and in the second reactor (R2) propylene terpolymer PPF2 is produced, yielding the bimodal propylene terpolymer.

Polymerization processes which are suitable for producing the propylene terpolymer generally comprises at least two polymerization stages and each stage can be carried out in solution, slurry, fluidized bed, bulk or gas phase.

The term “polymerization reactor” shall indicate that the main polymerization takes place. Thus in case the process consists of at least two polymerization reactors, this definition does not exclude the option that the overall system comprises for instance a pre-polymerization step in a pre-polymerization reactor. The term “consist of” is only a closing formulation in view of the main polymerization reactors.

The term “sequential polymerization process” indicates that the propylene terpolymer is produced in at least two reactors connected in series. Accordingly, such a polymerization system comprises at least a first polymerization reactor (R1) and a second polymerization reactor (R2), and optionally a third polymerization reactor (R3).

The first polymerization reactor (R1) is preferably a slurry reactor and can be any continuous or simple stirred batch tank reactor or loop reactor operating in bulk or slurry. Bulk means a polymerization in a reaction medium that comprises of at least 60% (w/w) monomer. According to the present invention, the slurry reactor is preferably a (bulk) loop reactor. In case a “sequential polymerization process” is applied the second polymerization reactor (R2) and the optional third polymerization reactor (R3) are gas phase reactors (GPRs), i.e. a first gas phase reactor (GPR1) and a second gas phase reactor (GPR2). A gas phase reactor (GPR) according to this invention is preferably a fluidized bed reactor, a fast fluidized bed reactor or a settled bed reactor or any combination thereof.

A preferred multistage process is a “loop-gas phase”-process, such as developed by Borealis (known as BORSTAR® technology) described e.g. in patent literature, such as in EP 0 887 379, WO 92/12182, WO 2004/000899, WO 2004/111095, WO 99/24478, WO 99/24479 or in WO 00/68315.

A further suitable slurry-gas phase process is the Spheripol® process of Basell.

Preferably, the bimodal propylene terpolymer according to this invention is produced in the presence of a phthalate free Ziegler-Natta catalyst.

The Ziegler-Natta catalyst is fed into the first polymerization reactor (R1) and is then transferred with the polymer (slurry) obtained in the first polymerization reactor (R1) into the subsequent reactors.

If the process covers also a pre-polymerization step, it is preferred that all of the Ziegler-Natta catalyst is fed in the pre-polymerization reactor. Subsequently the pre-polymerization product containing the Ziegler-Natta catalyst is transferred into the first polymerization reactor (R1).

This Ziegler-Natta catalyst can be any stereo-specific Ziegler-Natta catalyst for propylene polymerization, which preferably is capable of catalysing the polymerization and copolymerization of propylene and comonomers at a pressure of 500 to 10000 kPa, in particular 2500 to 8000 kPa, and at a temperature of 40 to 110° C., in particular of 60 to 110° C. Preferably, the Ziegler-Natta catalyst (ZN-C) comprises a high-yield Ziegler-Natta type catalyst including an internal donor component, which can be used at high polymerization temperatures of 80° C. or more.

Such high-yield Ziegler-Natta catalyst (ZN-C) can comprise a succinate, a diether, etc., or mixtures therefrom as internal donor (ID) and are for example commercially available for example from LyondellBasell under the Avant ZN trade name.

Further useful solid catalysts are prepared by emulsion-solidification method, where no external support is needed. The dispersed phase in the form of liquid droplets of the emulsion forms the catalyst part, which is transformed to solid catalyst particles during the solidification step.

A further suitable catalyst for the present invention is a solid Ziegler-Natta catalyst, which comprises compounds of a transition metal of Group 4 to 6 of IUPAC, like titanium, a Group 2 metal compound, like a magnesium, and an internal donor being a non-phthalic compound, more preferably a non-phthalic acid ester, still more preferably being a diester of non-phthalic dicarboxylic acids as described in more detail below. Further, the solid catalyst is free of any external support material, like silica or MgCl2, but the catalyst is self-supported.

This Ziegler-Natta catalyst can be further defined by the way as obtained.

Accordingly, the Ziegler-Natta catalyst is preferably obtained by a process comprising the steps of

a)
a1) providing a solution of at least a Group 2 metal alkoxy compound (Ax) being the reaction product of a Group 2 metal compound and a monohydric alcohol (A) comprising in addition to the hydroxyl moiety at least one ether moiety optionally in an organic liquid reaction medium; or
a2) a solution of at least a Group 2 metal alkoxy compound (Ax′) being the reaction product of a Group 2 metal compound and an alcohol mixture of the monohydric alcohol (A) and a monohydric alcohol (B) of formula ROH, optionally in an organic liquid reaction medium; or
a3) providing a solution of a mixture of the Group 2 alkoxy compound (Ax) and a Group 2 metal alkoxy compound (Bx) being the reaction product of a Group 2 metal compound and the monohydric alcohol (B), optionally in an organic liquid reaction medium; or
a4) providing a solution of Group 2 alkoxide of formula M(OR1)n(OR2)mX2-n-m or mixture of Group 2 alkoxides M(OR1)n′X2-n′ and M(OR2)m′X2-m′, where M is Group 2 metal, X is halogen, R1 and R2 are different alkyl groups with C2 to C16 carbon atoms, and 0<n<2, 0<m<2 and n+m+(2−n−m)=2, provided that both n and m≠0, 0<n′<2 and 0<m′<2; and
b) adding said solution from step a) to at least one compound of a transition metal of Group 4 to 6 and
c) obtaining the solid catalyst component particles,
and adding a non-phthalic internal donor, at any step prior to step c).

The internal donor or precursor thereof is added preferably to the solution of step a).

According to the procedure above the Ziegler-Natta catalyst can be obtained via precipitation method or via emulsion (liquid/liquid two-phase system)—solidification method depending on the physical conditions, especially temperature used in steps b) and c).

In both methods (precipitation or emulsion-solidification) the catalyst chemistry is the same.

In precipitation method combination of the solution of step a) with at least one transition metal compound in step b) is carried out and the whole reaction mixture is kept at least at 50° C., more preferably in the temperature range of 55° C. to 110° C., more preferably in the range of 70° C. to 100° C., to secure full precipitation of the catalyst component in form of a solid particles (step c).

In emulsion—solidification method in step b) the solution of step a) is typically added to the at least one transition metal compound at a lower temperature, such as from −10° C. to below 50° C., preferably from −5° C. to 30° C. During agitation of the emulsion the temperature is typically kept at −10 to below 40° C., preferably from −5° C. to 30° C. Droplets of the dispersed phase of the emulsion form the active catalyst composition. Solidification (step c) of the droplets is suitably carried out by heating the emulsion to a temperature of 70° C. to 150° C., preferably to 80° C. to 110° C.

The catalyst prepared by emulsion—solidification method is preferably used in the present invention.

In a preferred embodiment in step a) the solution of a2) or a3) are used, i.e. a solution of (Ax′) or a solution of a mixture of (Ax) and (Bx).

Preferably the Group 2 metal is magnesium.

The magnesium alkoxy compounds (Ax), (Ax′) and (Bx) can be prepared in situ in the first step of the catalyst preparation process, step a), by reacting the magnesium compound with the alcohol(s) as described above, or said magnesium alkoxy compounds can be separately prepared magnesium alkoxy compounds or they can be even commercially available as ready magnesium alkoxy compounds and used as such in the catalyst preparation process of the invention.

Illustrative examples of alcohols (A) are monoethers of dihydric alcohols (glycol monoethers). Preferred alcohols (A) are C2 to C4 glycol monoethers, wherein the ether moieties comprise from 2 to 18 carbon atoms, preferably from 4 to 12 carbon atoms. Preferred examples are 2-(2-ethylhexyloxy)ethanol, 2-butyloxy ethanol, 2-hexyloxy ethanol and 1,3-propylene-glycol-monobutyl ether, 3-butoxy-2-propanol, with 2-(2-ethylhexyloxy)ethanol and 1,3-propylene-glycol-monobutyl ether, 3-butoxy-2-propanol being particularly preferred.

Illustrative monohydric alcohols (B) are of formula ROH, with R being a straight-chain or branched C₆-C₁₀ alkyl residue. The most preferred monohydric alcohol is 2-ethyl-1-hexanol or octanol.

Preferably a mixture of Mg alkoxy compounds (Ax) and (Bx) or mixture of alcohols (A) and (B), respectively, are used and employed in a mole ratio of Bx:Ax or B:A from 8:1 to 2:1, more preferably 5:1 to 3:1.

Magnesium alkoxy compound may be a reaction product of alcohol(s), as defined above, and a magnesium compound selected from dialkyl magnesiums, alkyl magnesium alkoxides, magnesium dialkoxides, alkoxy magnesium halides and alkyl magnesium halides. Alkyl groups can be a similar or different C1-C20 alkyl, preferably C2-C10 alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesiums are used. Most preferred dialkyl magnesiums are butyl octyl magnesium or butyl ethyl magnesium.

It is also possible that magnesium compound can react in addition to the alcohol (A) and alcohol (B) also with a polyhydric alcohol (C) of formula R″(OH)m to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium alkoxy compounds of step a) are thus selected from the group consisting of magnesium dialkoxides, diaryloxy magnesiums, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solvents to be employed for the preparation of the present catalyst may be selected among aromatic and aliphatic straight chain, branched and cyclic hydrocarbons with 5 to 20 carbon atoms, more preferably 5 to 12 carbon atoms, or mixtures thereof. Suitable solvents include benzene, toluene, cumene, xylol, pentane, hexane, heptane, octane and nonane. Hexanes and pentanes are particular preferred.

Mg compound is typically provided as a 10 to 50 wt % solution in a solvent as indicated above. Typical commercially available Mg compound, especially dialkyl magnesium solutions are 20-40 wt % solutions in toluene or heptanes.

The reaction for the preparation of the magnesium alkoxy compound may be carried out at a temperature of 40° C. to 70° C. Most suitable temperature is selected depending on the Mg compound and alcohol(s) used.

The transition metal compound of Group 4 to 6 is preferably a titanium compound, most preferably a titanium halide, like TiCl₄.

The non-phthalic internal donor that can be used in the preparation of the catalyst is preferably selected from (di)esters of non-phthalic carboxylic (di)acids, 1,3-diethers, derivatives and mixtures thereof. Especially preferred donors are diesters of mono-unsaturated dicarboxylic acids, in particular esters belonging to a group comprising malonates, maleates, succinates, citraconates, glutarates, cyclohexene-1,2-dicarboxylates and benzoates, and any derivatives and/or mixtures thereof. Preferred examples are e.g. substituted maleates and citraconates, most preferably citraconates.

In emulsion method, the two phase liquid-liquid system may be formed by simple stirring and optionally adding (further) solvent(s) and additives, such as the turbulence minimizing agent (TMA) and/or the emulsifying agents and/or emulsion stabilizers, like surfactants, which are used in a manner known in the art for facilitating the formation of and/or stabilize the emulsion. Preferably, surfactants are acrylic or methacrylic polymers. Particular preferred are unbranched C₁₂ to C₂₀ (meth)acrylates such as poly(hexadecyl)-methacrylate and poly(octadecyl)-methacrylate and mixtures thereof. Turbulence minimizing agent (TMA), if used, is preferably selected from alpha-olefin polymers of alpha-olefin monomers with 6 to 20 carbon atoms, like polyoctene, polynonene, polydecene, polyundecene or polydodecene or mixtures thereof. Most preferable it is polydecene.

The solid particulate product obtained by precipitation or emulsion—solidification method may be washed at least once, preferably at least twice, most preferably at least three times with an aromatic and/or aliphatic hydrocarbons, preferably with toluene, heptane or pentane. The catalyst can further be dried, as by evaporation or flushing with nitrogen, or it can be slurried to an oily liquid without any drying step.

The finally obtained Ziegler-Natta catalyst is desirably in the form of particles having generally an average particle size range of 5 to 200 μm, preferably 10 to 100. Particles are compact with low porosity and have surface area below 20 g/m², more preferably below 10 g/m². Typically, the amount of Ti is 1 to 6 wt %, Mg 10 to 20 wt % and donor 10 to 40 wt % of the catalyst composition.

Detailed description of preparation of catalysts is disclosed in WO 2012/007430, EP2610271, EP261027 and EP2610272.

The Ziegler-Natta catalyst is optionally modified by the so called BNT-technology during a pre-polymerization step in order to introduce a polymeric nucleating agent.

Such a polymeric nucleating agent is preferably a vinyl polymer, such as a vinyl polymer derived from monomers of the formula

CH₂=CH—CHR¹R²

wherein R¹ and R², together with the carbon atom they are attached to, form an optionally substituted saturated or unsaturated or aromatic ring or a fused ring system, wherein the ring or fused ring moiety contains 4 to 20 carbon atoms, preferably 5 to 12 membered saturated or unsaturated or aromatic ring or a fused ring system or independently represent a linear or branched C₄-C₃₀-alkane, C₄-C₂₀-cycloalkane or C₄-C₂₀-aromatic ring. Preferably R¹ and R², together with the C-atom wherein they are attached to, form a five- or six-membered saturated or unsaturated or aromatic ring or independently represent a lower alkyl group comprising from 1 to 4 carbon atoms. Preferred vinyl compounds for the preparation of a polymeric nucleating agent to be used in accordance with the present invention are in particular vinyl cycloalkanes, in particular vinyl cyclohexane (VCH), vinyl cyclopentane, and vinyl-2-methyl cyclohexane, 3-methyl-1-butene, 3-ethyl-1-hexene, 3-methyl-1-pentene, 4-methyl-1-pentene or mixtures thereof. VCH is a particularly preferred monomer.

The weight ratio of vinyl compound to polymerization catalyst in the modification step of the polymerization catalyst preferably is 0.3 or more up to 40.0, such as 0.4 to 20.0 or more preferably 0.5 to 15.0, like 0.5 to 2.0.

The polymerization of the vinyl compound, e. g. VCH, can be done in any inert fluid that does not dissolve the polymer formed (e. g. polyVCH). It is important to make sure that the viscosity of the final catalyst/polymerized vinyl compound/inert fluid mixture is sufficiently high to prevent the catalyst particles from settling during storage and transport.

The adjustment of the viscosity of the mixture can be done either before or after the polymerization of the vinyl compound. It is, e.g., possible to carry out the polymerization in a low viscosity oil and after the polymerization of the vinyl compound the viscosity can be adjusted by addition of a highly viscous substance. Such highly viscous substance can be a “wax”, such as an oil or a mixture of an oil with a solid or highly viscous substance (oil-grease). The viscosity of such a viscous substance is usually 1,000 to 15,000 cP at room temperature. The advantage of using wax is that the catalyst storing and feeding into the process is improved. Since no washing, drying, sieving and transferring are needed, the catalyst activity is maintained.

The weight ratio between the oil and the solid or highly viscous polymer is preferably less than 5:1.

In addition to viscous substances, liquid hydrocarbons, such as isobutane, propane, pentane and hexane, can also be used as a medium in the modification step.

The polypropylenes produced with a catalyst modified with polymerized vinyl compounds contain essentially no free (unreacted) vinyl compounds. This means that the vinyl compounds shall be completely reacted in the catalyst modification step. To that end, the weight ratio of the (added) vinyl compound to the catalyst should be in the range of 0.05 to 10.0, preferably less than 3.0, more preferably about 0.1 to 2.0, and in particular about 0.1 to 1.5. It should be noted that no benefits are achieved by using vinyl compounds in excess.

Further, the reaction time of the catalyst modification by polymerization of a vinyl compound should be sufficient to allow for complete reaction of the vinyl monomer, i.e. the polymerization is continued until the amount of unreacted vinyl compounds in the reaction mixture (including the polymerization medium and the reactants) is less than 0.5 wt %, in particular less than 2000 ppm by weight (shown by analysis). Thus, when the pre-polymerized catalyst contains a maximum of about 0.1 wt % vinyl compound, the final vinyl compound content in the polypropylene will be below the limit of determination using the GC-MS method (<0.01 ppm by weight). Generally, when operating on an industrial scale, a polymerization time of at least 30 minutes is required, preferably the polymerization time is at least 1 hour and in particular at least 5 hours. Polymerization times even in the range of 6 to 50 hours can be used. The modification can be done at temperatures of 10° C. to 60° C., preferably 15° C. to 55° C.

General conditions for the modification of the catalyst are also disclosed in WO 00/6831.

The preferred embodiments as described previously in the present application with respect to the vinyl compound also apply with respect to the polymerization catalyst of the present invention and the preferred polypropylene composition in accordance with the present invention.

Suitable media for the modification step include, in addition to oils, also aliphatic inert organic solvents with low viscosity, such as pentane and heptane. Furthermore, small amounts of hydrogen can be used during the modification.

The Ziegler-Natta catalyst is preferably used in association with an alkyl aluminum cocatalyst and optionally external donors.

As further component in the instant polymerization process an external donor is preferably present. Suitable external donors include certain silanes, ethers, esters, amines, ketones, heterocyclic compounds and blends of these. It is especially preferred to use a silane. It is most preferred to use silanes of the general formula

R^{a}ₚR^{b}_{q}Si(OR^{c})_{(4-p-q)}

wherein R^{a}, R^{b} and R^{c} denote a hydrocarbon radical, in particular an alkyl or cycloalkyl group, and wherein p and q are numbers ranging from 0 to 3 with their sum p+q being equal to or less than 3. R^{a}, R^{b} and R^{c} can be chosen independently from one another and can be the same or different. Specific examples of such silanes are (tert-butyl)₂Si(OCH₃)₂, (cyclohexyl)(methyl)Si(OCH₃)₂, (phenyl)₂Si(OCH₃)₂ and (cyclopentyl)₂Si(OCH₃)₂, or of general formula

Si(OCH₂CH₃)₃(NR³R⁴)

wherein R³ and R⁴ can be the same or different a represent a hydrocarbon group having 1 to 12 carbon atoms.

R³ and R⁴ are independently selected from the group consisting of linear aliphatic hydrocarbon group having 1 to 12 carbon atoms, branched aliphatic hydrocarbon group having 1 to 12 carbon atoms and cyclic aliphatic hydrocarbon group having 1 to 12 carbon atoms. It is in particular preferred that R³ and R⁴ are independently selected from the group consisting of methyl, ethyl, n-propyl, n-butyl, octyl, decanyl, iso-propyl, iso-butyl, iso-pentyl, tert.-butyl, tert.-amyl, neopentyl, cyclopentyl, cyclohexyl, methylcyclopentyl and cycloheptyl.

More preferably both R³ and R⁴ are the same, yet more preferably both R³ and R⁴ are an ethyl group.

Especially preferred external donors are the dicyclopentyl dimethoxy silane donor (D-donor) or the cyclohexylmethyl dimethoxy silane donor (C-Donor).

In addition to the Ziegler-Natta catalyst and the optional external donor, a co-catalyst can be used. The co-catalyst is preferably a compound of group 13 of the periodic table (IUPAC), e.g. organo aluminum, such as an aluminum compound, like aluminum alkyl, aluminum halide or aluminum alkyl halide compound. Accordingly, in one specific embodiment the co-catalyst is a trialkylaluminium, like triethylaluminium (TEAL), dialkyl aluminium chloride or alkyl aluminium dichloride or mixtures thereof. In one specific embodiment the co-catalyst is triethylaluminium (TEAL).

Preferably the ratio between the co-catalyst (Co) and the external donor (ED) [Co/ED] and/or the ratio between the co-catalyst (Co) and the transition metal (TM) [Co/TM] should be carefully chosen.

Accordingly,

(a) the mol-ratio of co-catalyst (Co) to external donor (ED) [Co/ED] must be in the range of from 5.0 to 45.0, preferably is in the range of from 5.0 to 35.0, more preferably is in the range of from 5.0 to 25.0; and optionally
(b) the mol-ratio of co-catalyst (Co) to titanium compound (TC) [Co/TC] must be in the range of above 80.0 to 500.0, preferably is in the range of from 100.0 to 350.0, still more preferably is in the range of from 120.0 to 300.0.

The bimodal propylene terpolymer used according to this invention is thus preferably produced in the presence of

(a) a Ziegler-Natta catalyst comprising an internal non-phthalic donor,
(b) optionally a co-catalyst (Co), and
(c) optionally an external donor (ED).

The bimodal propylene terpolymer of the present invention may optionally contain one or more additives in a total amount of from 0.0 up to 5.0 wt %, based on the composition, selected from the group comprising slip agents, anti-block agents, UV stabilizers, acid scavengers, anti-oxidants, alpha and/or beta nucleating agents, antistatic agents, etc.

Such additives are commonly known to an art skilled person.

Slip agents are also commonly known in the art. Slip agents migrate to the surface and act as lubricants polymer to polymer and polymer against metal rollers, giving reduced coefficient of friction (CoF) as a result. Examples are fatty acid amides, like erucamides (CAS No. 112-84-5), oleamides (CAS No. 301-02-0) or stearamide (CAS No. 124-26-5).

Examples of antioxidants which are commonly used in the art, are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), or antioxidant blends.

Acid scavengers are also commonly known in the art. Examples are calcium stearates, sodium stearates, zinc stearates, magnesium and zinc oxides, synthetic hydrotalcite (e.g. SHT, CAS-no. 11097-59-9), lactates and lactylates, as well as calcium stearate (CAS 1592-23-0) and zinc stearate (CAS 557-05-1);

Common antiblocking agents are natural silica such as diatomaceous earth (such as CAS-no. 60676-86-0 (SuperfFloss™), CAS-no. 60676-86-0 (SuperFloss E™), or CAS-no. 60676-86-0 (Celite 499™)), synthetic silica (such as CAS-no. 7631-86-9, CAS-no. 7631-86-9, CASno. 7631-86-9, CAS-no. 7631-86-9, CAS-no. 7631-86-9, CAS-no. 7631-86-9, CAS-no. 112926-00-8, CAS-no. 7631-86-9, or CAS-no. 7631-86-9), silicates (such as aluminium silicate (Kaolin) CAS-no. 1318-74-7, sodium aluminum silicate CAS-no. 1344-00-9, calcined kaolin CAS-no. 92704-41-1, aluminum silicate CAS-no. 1327-36-2, or calcium silicate CAS-no. 1344-95-2), synthetic zeolites (such as sodium calcium aluminosilicate hydrate CAS-no. 1344-01-0, CAS-no. 1344-01-0, or sodium calcium aluminosilicate, hydrate CAS-no. 1344-01-0)

Suitable UV-stabilisers are, for example, Bis-(2,2,6,6-tetramethyl-4-piperidyl)-sebacate (CAS 52829-07-9, Tinuvin 770); 2-hydroxy-4-n-octoxy-benzophenone (CAS 1843-05-6, Chimassorb 81) Alpha nucleating agents like sodium benzoate (CAS 532-32-1); 1,3:2,4-bis(3,4-dimethylbenzylidene)sorbitol (CAS 135861-56-2, Millad 3988).

Suitable antistatic agents are, for example, glycerol esters (CAS No. 97593-29-8) or ethoxylated amines (CAS No. 71786-60-2 or 61791-31-9) or ethoxylated amides (CAS No. 204-393-1).

Usually these additives are added in quantities of 100-2.000 ppm for each single component.

The optional additives are added to the propylene terpolymer during its production, i.e. during pelletization.

Generally, the propylene terpolymer according to the invention has a sealing initiation temperature (SIT) in the range of 90 to <108° C., preferably in the range of 95 to 107° C. The sealing initiation temperature (SIT) is measured on a 50 μm cast film in principle according to the norm ASTM F1921—12 Method A, which has been modified as described in the experimental part.

Alternatively, the propylene terpolymer has a xylene cold soluble (XCS) content measured according to ISO 6427 of below 25.0 wt %, more preferably of below 23.0 wt %, even more preferably of below 20.0 wt %, like below 18.0 wt %. Generally the propylene terpolymer according to the invention has a xylene cold soluble fraction (XCS) in the range of 5.0 to below 25.0 wt %, preferably in the range of 8.0 to 23.0 wt %, more preferably in the range of 10.0 to 20.0 wt %. The xylene soluble fraction is determined at 25° C. according to ISO 16152, 2005.

The propylene terpolymer preferably has a hexane extractable fraction as determined according to the FDA method (federal registration FDA § 177.1520 paragraph (a)(3)(ii)) on cast films of 100 μm thickness of not higher than 4.5 wt %, preferably in the range of 2.0 to 4.2 wt %, more preferably in the range of 2.2 to 4.0 wt %.

### Use

The present invention is not only directed to the instant bimodal propylene terpolymer but also the use of the bimodal propylene terpolymer for preparing articles and the articles comprising the bimodal propylene terpolymer.

Suitable articles are films for flexible packaging systems, such as bags or pouches for food and pharmaceutical packaging or medical articles in general.

In an embodiment the present invention is related to an article, the article being an unoriented mono-layer film comprising the inventive bimodal propylene terpolymer. Accordingly the present invention is also directed to an article, the article being an unoriented mono-layer film, like cast film or blown film, e.g. air cooled blown film, comprising at least 90 wt %, preferably comprising at least 95 wt %, yet more preferably comprising at least 99 wt %, of the instant bimodal propylene terpolymer.

In another embodiment the present invention is related to an article, the article being an biaxially oriented mono-layer film comprising the inventive bimodal propylene terpolymer. Accordingly the present invention is also directed to an article, the article being an biaxially oriented mono-layer film, like cast film or blown film, e.g. air cooled blown film, comprising at least 90 wt %, preferably comprising at least 95 wt %, yet more preferably comprising at least 99 wt %, of the instant bimodal propylene terpolymer.

The above described composition is suitable for the production of blown films as well as cast films.

### Description of Film Production by Blown Film Technology

The above described composition is capable of being manufactured into water or air quench blown films, preferably air quenched blown films, on typical polyethylene blown film production equipment.

In principle the process comprising the steps of

(i) blowing up a tube of molten material with air perpendicularly to the upwards direction from a side-fed blown film die;
(ii) cooling it down with water contact cooling ring or air quench;
(iii) folding it and guiding it over deflector rolls onto the winder

In the blown film process the polypropylene composition melt is extruded through an annular die and blown into a tubular film by forming a bubble which is collapsed between nip rollers after solidification. The blown extrusion can be preferably effected at a temperature in the range 160° C. to 240° C., and cooled by water or preferably by blowing gas (generally air) at a temperature of 10° C. to 50° C. to provide a frost line height of 0.5 to 8 times the diameter of the die. The blow up ratio should generally be in the range of from 1.5 to 4, such as from 2 to 4, preferably 2.5 to 3.5.

### Description of Film Production by Cast Film Technology

In this most simple technology for producing polymer films, the molten blend is extruded through a slot die fed by a (normally single-screw) extruder onto a first cooled roll, the socalled chill-roll. From this roll, the already solidified film is taken up by a second roll (nip roll or take-up roll) and transported to a winding device after trimming the edges. Only a very limited amount of orientation is created in the film, which is determined by the ratio between die thickness and film thickness or the extrusion speed and the take-up speed, respectively.

Due to its technical simplicity, cast film technology is a very economical and easy-to-handle process. The films resulting from this technology are characterised by good transparency and rather isotropic mechanical properties (limited stiffness, high toughness).

Summing up the process comprises the steps of

i) pouring or spreading a solution, hot-melt or dispersion of a material onto a temporary carrier
ii) hardening the material, and
iii) stripping the hardened film from the surface of the carrier.

In case a film is produced by cast film technology the molten polypropylene composition is extruded through a slot extrusion die onto a chill roll to cool the polypropylene composition to a solid film. Typically the polypropylene composition is firstly compressed and liquefied in an extruder, it being possible for any additives to be already added to the polypropylene composition or introduced at this stage via a masterbatch. The melt is then forced through a flat-film die (slot die), and the extruded film is taken off on one or more take-off rolls, during which it cools and solidifies. It has proven particularly favorable to keep the take-off roll or rolls, by means of which the extruded film is cooled and solidified, at a temperature from 10° C. to 50° C., preferably from 15° C. to 40° C.

Mono-layer films having a thickness of 5 to 300 μm, preferably 10 to 200 μm, more preferably 20 to 150 μm are suitable according to the present invention.

It has been found that such a bimodal propylene terpolymer according to the present invention provides the film material made thereof with a combination of low sealing initiation temperature (SIT), high melting point, high hot-tack and beneficial optical properties, i.e. low haze.

In a further aspect the present invention is related to the use of the mono-layer films according to the invention for lamination films or multilayer films for packaging films and medical/hygienic films, wherein the mono-layer films according to the invention comprise at least one layer.

As alternative in one further aspect the present invention is related to the use of the monolayer films according to the invention as sealing layer in a polypropylene multi-layer film, which can be manufactured either by co-extrusion or lamination.

Further, the invention is also directed to a multi-layer film construction, comprising an unoriented mono-layer film as defined above as an outermost layer, i.e as sealing layer.

Further, the invention is also directed to a multi-layer film construction, comprising an biaxially oriented mono-layer film as defined above as an outermost layer, i.e as sealing layer.

Unoriented mono-layer films comprising the bimodal random propylene terpolymer of the present invention have a hot-tack force in the range of from 1.5 to 6.0 N (measured on a 50 μm cast film). The hot-tack force of the polypropylene composition containing films is measured according to ASTM F1921-12—Method B.

It is preferred that the hot-tack force measured on a 50 μm cast film is in the range of from 1.8 to 5.0 N, more preferably in the range of from 2.0 to 4.5 N and even more preferably in the range of from 2.0 to 4.0 N.

Furthermore such an unoriented film comprising the inventive bimodal random propylene terpolymer shall preferably have a haze determined on 50 μm cast film of below 3.0% more preferably of below 2.0% and even more preferably of below 1.5%.

The tensile modulus in machine (MD) direction (determined acc. to ISO 527-3 on cast films with a thickness of 50 μm) of such unoriented film comprising the inventive bimodal random propylene terpolymer shall preferably be at least 200 MPa, more preferably at least 250 MPA. A suitable upper limit is 500 MPa. Thus, the tensile modulus in machine (MD) direction (determined acc. to ISO 527-3 on cast films with a thickness of 50 μm) shall preferably be in the range of at least 200 MPa up to 500 MPa.

A further embodiment of the present invention is therefore also a cast film, wherein the cast film has

i. a sealing initiation temperature (SIT), measured on a 50 μm cast film, in the range of 90 to <108° C., preferably in the range of 95 to 107° C.,
ii. a haze according to ASTM D1003-00 determined on 50 μm cast film of below 3.0%, preferably below 2.0%,
iii. a hot-tack force determined on 50 μm cast film in the range of from 1.8 to 5.0 N, preferably 2.0 to 4.5 N and
iv. a tensile modulus in machine (MD) direction (determined acc. to ISO 527-3 on cast films with a thickness of 50 μm) in the range of at least 200 MPa up to 500 MPa.

Such cast films are made from polypropylene, preferably made from the inventive bimodal random terpolymer.

A multi-layer film construction comprising at least one layer comprising the inventive bimodal random propylene terpolymer is preferably produced by a lamination process or by multi-layer co-extrusion followed by film casting or film blowing. In this case, at least one of the outermost layers of said multi-layer film construction serving as sealing layer(s) shall comprise the inventive bimodal random propylene terpolymer as defined above. The inventive multilayer film construction shall preferably have a thickness in the range of 30 to 500 μm, more preferably in the range of 50 to 400 μm, like in the range of 60 to 300 μm. The sealing layer(s) comprising the inventive polypropylene composition shall preferably have a thickness in the range of 3 to 50 μm, more preferably in the range of 5 to 30 μm, like in the range of 8 to 25 μm.

Films and/or multi-layer film constructions according to the present invention shall preferably be used for flexible packaging systems, such as bags or pouches for food and pharmaceutical packaging or medical articles in general.

### Examples

### Measuring Methods

The following definitions of terms and determination methods apply for the above general description of the invention as well as to the below examples, unless otherwise defined.

### a) Melt Flow Rate

The melt flow rate (MFR) is determined according to ISO 1133 and is indicated in g/10 min. The MFR is an indication of the flowability and hence the processability of the polymer. The higher the melt flow rate, the lower the viscosity of the polymer. The MFR₂ of polypropylene is determined at a temperature of 230° C. and under a load of 2.16 kg.

### b) Melt Flow Rate (MFR₂) for the Propylene Terpolymer (PPF2)

The MFR₂ for the propylene terpolymer (PPF2) is calculated using the below formula:

In(MFR₂ of the polypropylene composition)=x (In(MFR₂ of the propylene terpolymer (PPF1)))+(1-x)(In(MFR₂ of the propylene terpolymer (PPF2)));

wherein MFR₂ of the polypropylene composition means the MFR₂ of the PP composition according to the present invention and wherein
x=the weight ratio (wt %) of the propylene terpolymer (PPF1) based on the combined weight of the propylene terpolymer (PPF1) and the weight of the propylene terpolymer (PPF2) which is in total=1.

### c) Melting Temperature

The melting temperature, Tm, is determined by differential scanning calorimetry (DSC) according to ISO 11357-3 with a TA-Instruments 2920 Dual-Cell with RSC refrigeration apparatus and data station. A heating and cooling rate of 10° C./min is applied in a heat/cool/heat cycle between +23 and +210° C. The melting temperature (Tm) is being determined in the second heating step.

### d) Xylene Cold Soluble Fraction (XCS, Wt %)

The amount of the polymer soluble in xylene is determined at 25.0° C. according to ISO 16152; 2005.

### e) Comonomer Content

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (klimke06, parkinson07, castignolles09). Standard single-pulse excitation was employed utilising the NOE at short recycle delays of 3 s (pollard04, klimke06) and the RS-HEPT decoupling scheme (fillip05, griffin07). A total of 1024 (1 k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

Characteristic signals corresponding to the incorporation of 1-butene were observed and the comonomer content quantified in the following way. The amount isolated 1-butene incorporated in PBP sequences was quantified using the integral of the aB2 sites at 43.6 ppm accounting for the number of reporting sites per comonomer:

B=I_{αB2}/2

The amount consecutively incorporated 1-butene in PBBP sequences was quantified using the integral of the ααB2 site at 40.5 ppm accounting for the number of reporting sites per comonomer:

BB=2*I_{ααB2}

The total 1-butene content was calculated based on the sum of isolated and consecutively incorporated 1-butene:

Btotal=B+BB

Characteristic signals corresponding to the incorporation of ethylene were observed and the comonomer content quantified in the following way. The amount isolated ethylene incorporated in PEP sequences was quantified using the integral of the Say sites at 37.9 ppm accounting for the number of reporting sites per comonomer:

E=I_{Sαγ}/2

When characteristic signals corresponding to consecutive ethylene incorporation in PEEP sequences were observed the amount of such consecutively incorporated ethylene was quantified using the integral of S_{βδ} sites at 27 ppm accounting for the number of reporting sites per comonomer:

EE=I_{Sβδ}

With no sites indicative of consecutive ethylene incorporation in PEEE sequences observed the total ethylene comonomer content was calculated as:

Etotal=E+EE

Characteristic signals corresponding to regio defects were not observed (resconi00).

The amount of propene was quantified based on the main Sαα methylene sites at 46.7 ppm and compensating for the relative amount of methylene unit of propene in PBP, PBBP, PEP and PEEP sequences not accounted for:

Ptotal=I_{Sαα}+B+BB/2+E+EE/2

The total mole fraction of 1-butene in the polymer was then calculated as:

fB=(Btotal/(Etotal+Ptotal+Btotal)

The total mole fraction of ethylene in the polymer was then calculated as:

fE=(Etotal/(Etotal+Ptotal+Btotal)

The mole percent comonomer incorporation was calculated from the mole fractions:

B[mol %]=100*fB

E[mol %]=100*fE

The weight percent comonomer incorporation was calculated from the mole fractions:

B[wt %]=100*(fB*56.11)/((fE*28.05)+(fB*56.11)+((1−(fE+fB))*42.08))

E[wt %]=100*(fE*28.05)/((fE*28.05)+(fB*56.11)+((1−(fE+fB))*42.08)).
klimke06
Klimke, K., Parkinson, M., Piel, C., Kaminsky, W., Spiess, H. W., Wilhelm, M., Macromol. Chem. Phys. 2006; 207:382.
parkinson07
Parkinson, M., Klimke, K., Spiess, H. W., Wilhelm, M., Macromol. Chem. Phys. 2007; 208:2128. pollard04
Pollard, M., Klimke, K., Graf, R., Spiess, H. W., Wilhelm, M., Sperber, O., Piel, C., Kaminsky, W., Macromolecules 2004; 37:813.
filip05
Filip, X., Tripon, C., Filip, C., J. Mag. Resn. 2005, 176, 239
griffin07
Griffin, J. M., Tripon, C., Samoson, A., Filip, C., and Brown, S. P., Mag. Res. in Chem. 2007 45, S1, S198
castignolles09
Castignolles, P., Graf, R., Parkinson, M., Wilhelm, M., Gaborieau, M., Polymer 50 (2009) 2373 busico01
Resconi, L., Cavallo, L., Fait, A., Piemontesi, F., Chem. Rev. 2000, 100, 1253

The comonomer content of the propylene terpolymer (PPF2) is calculated using the below formula:

Comonomer content of the polypropylene composition=x (Comonomer content of the propylene terpolymer (PPF1))+(1−x)(Comonomer content of the propylene terpolymer (PPF2)).

x=the weight ratio (wt) of the propylene terpolymer (PPF1) based on the combined weight of the propylene terpolymer (PPF1) and the weight of the propylene terpolymer (PPF2) which is in total=1.

### f) Sealing Initiation Temperature (SIT), Sealing Range

The method determines the sealing temperature range (sealing range) of polypropylene films, in particular blown films or cast films according to ASTM F1921—12 modified as described below.

The sealing range is the temperature range, in which the films can be sealed according to conditions given below.

The lower limit (heat sealing initiation temperature (SIT)) is the sealing temperature at which a sealing force of ≥5 N is achieved. The upper limit (sealing end temperature (SET)) is identified as a temperature at one step before the film burns through.

The sealing range is determined on a J&B sealing device (Type 4000) with a cast film of 50 μm thickness with the following further parameters:
Specimen width: 25 mm
Sealing pressure: 0.67 N/mm²
Sealing time: 1 sec
Cooling time: 30 sec
Clamp separation rate: 42 mm/sec
Start temperature: 80° C.
End temperature: 150° C.
Sealing temperature interval (Increments): 5° C.
Specimens are sealed A to A at each sealing jaw (sealbar) temperature and seal force is determined at each step.

The SIT is determined at which the sealing force reaches 5 N.

### g) Cast Films on PM30 Cast Film Line

Films were produced on a PM30 cast film line, with a melt temperature of 250° C. and chill roll temperature of 10° C. The throughput was 4.5 kg/h. The film thickness is 50 μm. For films with 100 μm thickness (hexane solubles) the chill roll temperature was 40° C.

### h) Haze was Determined According to ASTM D1003-00 on the Cast Films of 50 μm Thickness.

### i) Hot-Tack Force

The hot-tack force was determined according to ASTM F1921-12—Method B on a J&B Hot-Tack Tester on a 50 μm thickness cast film.

All film test specimens were prepared in standard atmospheres for conditioning and testing at 23° C. (±2° C.) and 50% (±10%) relative humidity.

The minimum conditioning time of test specimen in standard atmosphere before start testing is at least 16 h. The minimum storage time between extrusion of film sample and start testing is at least 88 h.

The hot tack measurement determines the strength of heat seals formed in the films, immediately after the seal has been made and before it cools to ambient temperature. The hot-tack measurement was performed under the following conditions.

Film Specimen width: 25 mm.
Seal bar length: 50 mm
Seal bar width: 5 mm
Seal bar shape: flat

### Seal Pressure: 0.15 N/mm².

### Seal Time: 0.5 sec.

Cool time: 0.2 sec.
Peel Speed: 200 mm/sec.
Start temperature: 90° C.
End temperature: 140° C.

### Increments: 5° C.

The hot-tack force was measured as a function of temperature within the temperature range and with temperature increments as indicated above. The number of test specimens was at least 3 specimens per temperature. The output of this method is a hot tack curve; a force vs. temperature curve.

The hot tack force (HTF) is evaluated from the curve as the highest force (maximum peak value) with failure mode “peel”.

### j) Tensile Modulus

Tensile moduli in machine (MD) direction were determined acc. to ISO 527-3 on cast films with a thickness of 50 μm at a cross head speed of 100 mm/min.

### k) Hexane Soluble Fraction (C6 FDA)

The hexane-extractable fraction is determined according to FDA § 177.1520 paragraph (a)(3)(ii). 2.5 g (accurately weighed to 0.0001 g) of a 100 μm film which have a maximum size of 2×2 cm were transferred in a kettle. 11 n-hexan (spectrograde or higher) is added and the temperature of the n-hexane in the kettle is heated in 20-25 minutes to 50° C. If the temperature overshoots 50° C. the test needs to be discard. The extraction is performed for 2 hours at 50° C.

The hot solution is filtered through a coarse filter paper in an Erlenmeyer flask of 1 L capacity. The solution is evaporated under a nitrogen stream in small amounts. After evaporating the last batch, the erlenmeyer flask is washed with n-hexane and the wash n-hexane is evaporated under a nitrogen stream. The residue is dried in the vacuum oven over night at 90° C. and afterwards left in an desiccator for at least 2 hours. The net weight of the dry residue is determined gravimetrically to the nearest 0.0001 g.

The n-hexane content is then calculated in the following way:

$$n - hexane extractables in wt . - \% = \frac{net weight of residue in g}{weight of samples in g} * 100$$

### Preparation of the Catalyst

The catalyst used in the polymerization processes for the propylene terpolymer of the inventive examples (IE1-IE4) as well as for comparative Example (CE1) was prepared as follows:

### Used Chemicals:

20% solution in toluene of butyl ethyl magnesium (Mg(Bu)(Et), BEM), provided by Chemtura
2-ethylhexanol, provided by Amphochem
3-Butoxy-2-propanol—(DOWANOL™ PnB), provided by Dow
bis(2-ethylhexyl)citraconate, provided by SynphaBase
TiCl4, provided by Millenium Chemicals
Toluene, provided by Aspokem
Viscoplex® 1-254, provided by Evonik
Heptane, provided by Chevron

### Preparation of a Mg Alkoxy Compound

Mg alkoxide solution was prepared by adding, with stirring (70 rpm), into 11 kg of a 20 wt % solution in toluene of butyl ethyl magnesium (Mg(Bu)(Et)), a mixture of 4.7 kg of 2-ethylhexanol and 1.2 kg of butoxypropanol in a 20 l stainless steel reactor. During the addition the reactor contents were maintained below 45° C. After addition was completed, mixing (70 rpm) of the reaction mixture was continued at 60° C. for 30 minutes. After cooling to room temperature 2.3 kg g of the donor bis(2-ethylhexyl)citraconate was added to the Mg-alkoxide solution keeping temperature below 25° C. Mixing was continued for 15 minutes under stirring (70 rpm).

### Preparation of Solid Catalyst Component

20.3 kg of TiCl4 and 1.1 kg of toluene were added into a 20 l stainless steel reactor. Under 350 rpm mixing and keeping the temperature at 0° C., 14.5 kg of the Mg alkoxy compound prepared in example 1 was added during 1.5 hours. 1.7 l of Viscoplex® 1-254 and 7.5 kg of heptane were added and after 1 hour mixing at 0° C. the temperature of the formed emulsion was raised to 90° C. within 1 hour. After 30 minutes mixing was stopped catalyst droplets were solidified and the formed catalyst particles were allowed to settle. After settling (1 hour), the supernatant liquid was siphoned away. Then the catalyst particles were washed with 45 kg of toluene at 90° C. for 20 minutes followed by two heptane washes (30 kg, 15 min). During the first heptane wash the temperature was decreased to 50° C. and during the second wash to room temperature.

The thus obtained catalyst was used along with triethyl-aluminium (TEAL) as co-catalyst and dicyclopentyl dimethoxy silane (D-Donor) as donor for preparing the propylene terpolymer (a) used according to the present invention. Polymerization was done in Borstar plant with a pre-polymerization step, one loop reactor and 1 gas-phase reactor. The conditions can be seen in Table 1. For Comparative Example CE1 t-butyldimethoxymethyl silane was used as donor.

TABLE 1
Preparation of bimodal random propylene terpolymer

| Prepolymerization | | IE1 | IE2 | IE3 | CE1 | CE2 |
|---|---|---|---|---|---|---|
| TEAL/Ti | [mol/mol] | 191 | 120 | 110 | 109 | 139 |
| TEAL/donor | [mol/mol] | 6.4 | 6.3 | 6.4 | 6.3 | 7.0 |
| Temperature | [° C.] | 20 | 20 | 20 | 20 | 20 |
| Loop | | | | | | |
| Temperature | [° C.] | 70 | 60 | 60 | 70 | 65 |
| Split | [%] | 31 | 43 | 36 | 40 | 38 |
| H2/C3 ratio | [mol/kmol] | 1.1 | 1.0 | 1.0 | 0.6 | 0.9 |
| C2/C3 ratio | [mol/kmol] | 5.2 | 6.0 | 7.4 | — | — |
| C4/C3 ratio | [mol/kmol] | 152 | 225 | 231 | 80 | 109 |
| MFR2 (PPF1) | [g/10 min] | 4.3 | 3.8 | 3.7 | 4.7 | 4.5 |
| XCS (PPF1) | [wt %] | 5.0 | 5.7 | 7.4 | 3.5 | 4.3 |
| C2 content (PPF1) | [wt %] | 0.3 | 0.3 | 0.7 | 0.0 | 0.0 |
| C4 content (PPF1) | [wt %] | 6.6 | 9.5 | 8.3 | 5.3 | 4.9 |
| GPR 1 | | | | | | |
| Temperature | [° C.] | 75 | 75 | 75 | 75 | 75 |
| Pressure | [kPa] | 2500 | 1850 | 1817 | 2400 | 2300 |
| Split | [%] | 69 | 57 | 64 | 60 | 62 |
| H2/C3 ratio | [mol/kmol] | 34.8 | 25.9 | 23.1 | 14.4 | 23.4 |
| C2/C3 ratio | [mol/kmol] | 19.1 | 23,4 | 28.2 | 15.2 | 25.0 |
| C4/C3 ratio | [mol/kmol] | 195 | 198 | 147 | 141.1 | 204.6 |
| MFR2 | [g/10 min] | 5.3 | 5.4 | 5.0 | 5.2 | 5.2 |
| XCS | [wt %] | 19.2 | 18.6 | 12.1 | 22.3 | 21.7 |
| C2 content (PPF2) | [wt %] | 2.5 | 1.6 | 2.6 | 2.0 | 3.4 |
| C4 content (PPF2) | [wt %] | 9.8 | 9.7 | 8.8 | 10.6 | 10.2 |

C2 ethylene
C4 butene
H2/C3 ratio hydrogen/propylene feed ratio
C2/C3 ratio ethylene/propylene feed ratio
C4/C3 ratio butene/propylene feed ratio
GPR 1 1^{st} gas phase reactor
Loop Loop reactor

The so obtained terpolymers were melt blended with the below cited additives on a co-rotating twin screw extruder type Coperion ZSK 40 (screw diameter 40 mm, L/D ratio 38) at temperatures in the range of 170−190° C., using a high intensity mixing screw configuration with two sets of kneading blocks.

The terpolymers thus contained 500 ppm of Irganox 1010 (Pentaerythrityl-tetrakis(3-(3′,5′-di-tert. butyl-4-hydroxyphenyl)-propionate, CAS No. 6683-19-8), 500 ppm of Irgafos 168 (Tris (2,4-di-t-butylphenyl) phosphite, CAS No. 31570-04-4) and 400 ppm of Calcium stearate (CAS. No. 1592-23-0) as additives.

The terpolymer data described in Table 2 are measured on the pellets obtained after melt blending as described above.

TABLE 2
properties of propylene-ethylene-
1-butene random terpolymers

| Property | unit | IE1 | IE2 | IE3 | CE1 | CE2 |
|---|---|---|---|---|---|---|
| Total C2 | [wt %] | 1.8 | 1.6 | 2.1 | 1.2 | 2.1 |
| Total C4 | [wt %] | 8.4 | 9.7 | 8.5 | 8.5 | 8.2 |
| MFR₂ | [g/10 min] | 5.3 | 5.4 | 5.0 | 5.2 | 5.2 |
| Tm | [° C.] | 135 | 133 | 135 | 142 | 142 |
| XCS | [wt %] | 19.2 | 18.6 | 12.1 | 22.3 | 21.7 |
| C6 FDA | [wt %] | 2.7 | 4.0 | 3.2 | 3.9 | 4.8 |

In Table 3 the cast film properties (IE1-IE3, CE1-CE2) are shown:

TABLE 3

| Example | unit | IE1 | IE2 | IE3 | CE1 | CE2 |
|---|---|---|---|---|---|---|
| Tensile Modulus (MD) | [MPa] | 387 | 380 | 399 | 384 | 341 |
| Hot-tack force | [N] | 2.54 | 2.28 | 2.08 | 2.49 | 2.40 |
| SIT | [° C.] | 107 | 103 | 106 | 109 | 111 |
| Haze | [%] | 1.2 | 0.7 | 1.0 | 0.1 | 1.1 |

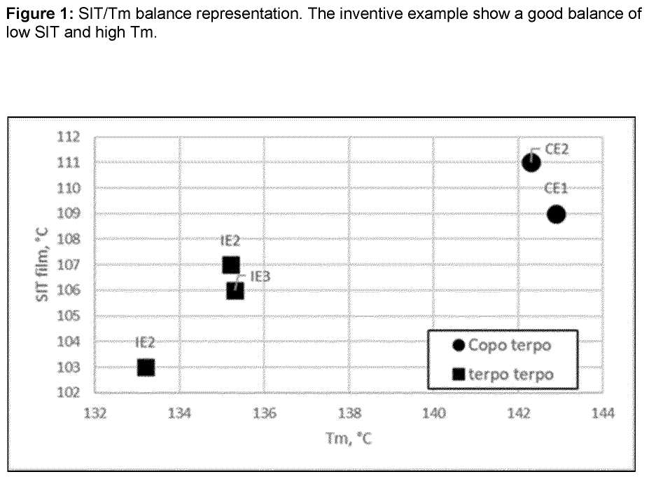

From Table 3 it can be derived that the bimodal random propylene terpolymer according to the invention has an improved SIT/Tm balance. This can be also seen in FIG. 1. The inventive example show low SIT and high Tm.

1. A bimodal random propylene terpolymer, being a binary blend comprising two propylene polymer fractions PPF1 and PPF2 in specific amounts:
a) 25.0 wt % to less than or equal to 50.0 wt % of propylene polymer fraction PPF1 that is a propylene terpolymer comprising propylene monomers, 0.1 to 0.8 wt % ethylene comonomer and 4.0 to 12.0 wt % of one comonomer selected from C₄-C₁₀ alpha-olefin, and
b) more than or equal to 50.0 wt % up to 75.0 wt % of propylene polymer fraction PPF2 that is a propylene terpolymer comprising propylene monomers, 1.0 to 5.0 wt % of ethylene comonomer and 4.0 to 15.0 wt % of one comonomer selected from C₄-C₁₀ alpha-olefin,
the amount of PPF1 and PPF2 being relative to the total sum of the propylene polymer fractions PPF1 and PPF2,
wherein the bimodal random propylene terpolymer has:
i) a melting temperature (Tm) in the range of 133 to 160° C. as determined by DSC according to ISO 11357,
ii) a sealing initiation temperature (SIT), measured on a 50 μm cast film, in the range of 90 to <108° C.,
iii) a total ethylene content in the range of 0.5 to 4.0 wt %, and
iv) a total C₄-C₁₀ alpha-olefin comonomer content in the range of 5.0 to 14.0 wt %.

2. The bimodal random propylene terpolymer according to claim 1, wherein the two propylene polymer fractions PPF1 and PPF2 are terpolymers of propylene, ethylene and 1-butene.

3. The bimodal random propylene terpolymer according to claim 1, wherein the bimodal random propylene terpolymer has a melting temperature Tm measured via DSC according to ISO 11357 in the range of 133 to 145° C.

4. The bimodal random propylene terpolymer according to claim 1, wherein the bimodal random propylene terpolymer has a xylene cold soluble (XCS) amount in the range of 5.0 to below 25.0 wt %, measured according to ISO 16152, 2005, at 25° C.

5. A process for producing the bimodal random propylene terpolymer according to claim 1 by a sequential polymerization process comprising at least two reactors connected in series, said process comprising the steps:
a) polymerizing in a first reactor (R-1) that is a slurry reactor propylene, ethylene and one comonomer selected from C₄-C₁₀ alpha-olefin to obtain a propylene polymer fraction (PPF1) that is a propylene terpolymer comprising propylene monomers, 0.1 to 0.8 wt % ethylene comonomer and 4.0 to 12.0 wt % of one comonomer selected from C₄-C₁₀ alpha-olefin,
b) transferring the propylene polymer fraction (PPF1) and unreacted comonomers of the first reactor (R-1) into a second reactor (R-2) that is a first gas-phase reactor-1 (GPR-1),
c) polymerizing in the first gas-phase reactor-1 (GPR-1) propylene, ethylene and one comonomer selected from C₄-C₁₀ alpha-olefin in the presence of the propylene polymer fraction (PPF1) to obtain a propylene polymer fraction (PPF2), that is a propylene terpolymer comprising propylene monomers, 1.0 to 5.0 wt % of ethylene comonomer and 4.0 to 15.0 wt % of one comonomer selected from C₄-C₁₀ alpha-olefin, said propylene polymer fraction (PPF2) and the propylene polymer fraction (PPF1) forming the bimodal random propylene terpolymer,
d) recovering the bimodal random propylene terpolymer.

6. (canceled)

7. An article comprising the bimodal random propylene terpolymer according to claim 1.

8. An article according to claim 7, wherein the article is an unoriented film comprising more than 90 wt % of the bimodal random propylene terpolymer according to claim 1, wherein the film is a cast film or a blown film.

9. The article according to claim 8, wherein the film has a haze according to ASTM D1003-00 determined on a 50 μm cast film of below 3.0%.

10. The article according to claim 8, wherein the film has a hot-tack force determined on a 50 μm cast film in the range of from 1.8 to 5.0 N.

11. A cast film, wherein the cast film has:
i) a sealing initiation temperature (SIT), measured on a 50 μm cast film, in the range of 90 to <108° C.,
ii) a haze according to ASTM D1003-00 determined on a 50 μm cast film of below 3.0%,
iii) a hot-tack force determined on a 50 μm cast film in the range of from 1.8 to 5.0 N, and
iv) a tensile modulus in machine (MD) direction, determined according to ISO 527-3 on cast films with a thickness of 50 μm, in the range of 200 MPa to 500 MPa.

12. (canceled)
